(19) United States
(12) Patent Application Publication
(10) Pub. No.: US 2001/0032482 A1
(43) Pub. Date: Oct. 25, 2001

(54) Method and apparatus for constructing optical waveguide components using electrostatic gun

(76) Inventor: Daniel W. Hawtof, Painted Post, NY (US)

Correspondence Address: Brian E. Ainsworth, Price, Heneveld, Cooper, DeWitt & Litton, 695 Kenmoor S.E., P.O. Box 2567, Grand Rapids, MI, 49501, US

(21) Appl. No.: 09/861,291

(22) Filed: May 18, 2001

Related U.S. Application Data
(63) Continuation-in-part of application No. 09/718,060, filed on Nov. 20, 2000.
(60) Provisional application No. 60/187,755, filed on Mar. 8, 2000.

(51) Int. Cl. C03B 19/06

(52) U.S. Cl. 65/17.4

(57) ABSTRACT

A method for producing an optical waveguide component includes providing a glass producing soot, providing a soot delivery device adapted to provide an electrostatic charge to the soot, and providing a substrate material adapted to receive the glass producing soot thereon. The method also includes delivering the soot to the delivery device, and accelerating the soot as it passes through the delivery device. The method further includes charging the soot as the soot is passed through the delivery device with a sufficient charge to attract the soot to the substrate material, and depositing the soot on the substrate material by spraying the soot onto the substrate material via the delivery device.

### CROSS-REFERENCE TO RELATED APPLICATIONS

This is a continuation-in-part of U.S. patent application Ser. No. 09/718,060, filed Nov. 20, 2000, entitled METHOD AND APPARATUS TO COLLECT SOOT FOR MELTS, which is hereby incorporated by reference, and which claims priority to U.S. Provisional Patent Application Ser. No. 60/187,755, filed Mar. 8, 2000, entitled METHOD AND APPARATUS TO COLLECT SOOT FOR MELTS, which is hereby incorporated herein by reference.

### BACKGROUND OF THE INVENTION

1. Field of the Invention

The present invention is generally related to manufacturing optical waveguides, components and products, and more particularly to an apparatus and method for applying a glass producing soot to a substrate.

2. Technical Background

One of the difficulties involved in most optical component manufacturing methods and processes is that of limiting attenuation losses in the resultant optical components. Attenuation loss is due, at least in part, to the difficulty and expense associated with obtaining soot materials of sufficient purity through heretofore utilized batch production methods. A need currently exists to produce and collect glass producing soot materials of sufficient purity via a waveguide burner.

Another problem associated with most optical component manufacturing processes is the inability to obtain glass producing soots that contain dopants beyond certain weight percents. One of the reasons for this limitation is that the temperatures associated with most soot producing waveguide burners is great enough to “bake-out” dopants within the resultant soot above a certain weight percent. Therefore, a need exists that allows for the production of glass producing soot that allows greater amounts of a particular dopant to remain in the soot as a weight percent during production of the soot. This process should utilize waveguide burners currently available to enable the use of a wide variety of soot compositions and dopants, a wide variety of soot particle sizes, and numerous soot collection devices.

Finally, typical soot producing systems utilize a single burner to produce soot that is deposited on a single substrate at a time. Methods that utilize conventional vapor delivery to the associated burner enable only a relatively narrow range of materials as dopants to be used. Further, scaling up of these systems would require the addition of entire wafer producing machines, and/or the addition of burners to each machine resulting in only a marginal increase in production rate. As a result of these limitations, a need exists for a method and apparatus for producing optical waveguide components more quickly and efficiently.

### SUMMARY OF THE INVENTION

This invention meets the need for a method and apparatus for producing optical waveguide devices in a low cost, high volume, high uniformity manufacturing process. Specifically, this invention utilizes electrostatic attraction forces to more quickly and effectively coat substrate materials with a glass producing soot.

One aspect of the present invention is to provide a method for producing an optical waveguide component, including providing a glass producing soot, providing a soot delivery device adapted to provide a charge to the soot, and providing a substrate material adapted to receive the glass producing soot thereon. The method further includes adapted to receive the glass producing soot thereon. The method further includes delivering the soot to the delivery device, and accelerating the soot as it passes through the device. The method further includes charging the soot as the soot passes through the delivery device with a sufficient electrostatic charge to attract the soot to the substrate material, and depositing the soot on the substrate material by spraying the soot onto the substrate material via the delivery device.

Another aspect of the present invention is to provide a method for producing an optical waveguide component that includes generating a glass-producing soot via a burner providing the generated soot to a surface area collector, and collecting the soot within the surface area collector, wherein the burner is disposed such that the soot collected in the surface area collector is substantially unaffected by the heat from the burner. The method also includes providing a soot delivery device adapted to provide a charge to the soot, and providing a substrate material adapted to receive the glass producing soot thereon. The method further includes delivering the soot from the surface area collector to the delivery device, accelerating the soot as it passes through the delivery device, electrically charging the soot as the soot passes through the delivery device with a sufficient electrostatic charge such that the soot is attracted to the substrate material, conveying a plurality of the substrates to a location proximate the delivery device, and depositing the soot on the plurality of substrates by spraying the soot onto the plurality of substrates via the delivery device. The method still further includes conveying the plurality of substrates from proximate the delivery device to a sintering oven, and sintering the plurality of substrates that have collected the soot, thereby allowing the resultant optical components to be made in a continuous-type process.

Yet another aspect of the present invention is to provide an apparatus for producing an optical waveguide component that includes an enclosure for housing a glass producing soot therein, and a soot delivery device in communication with the enclosure for receiving the delivery device in communication with the enclosure for receiving the glass producing soot therefrom. The soot delivery device is adapted to provide an electrical charge to the glass producing soot and accelerate the glass producing soot towards a substrate as the glass producing soot is passed through the soot delivery device, thereby causing an electrostatic attraction force between the glass producing soot and the substrate and depositing the glass producing soot onto the substrate.

Additional features and advantages of the invention will be set forth in the detailed description that follows and will be apparent to those skilled in the art from the description or recognized by practicing the invention as described in the description which follows, together with the claims and appended drawings.

It is to be understood that both the forgoing general description and the following detailed description are merely exemplary of the invention, and are intended to provide an overview for understanding the nature and character of the invention as it is claimed. The accompanying drawings are included to provide a further understanding of the invention, and are incorporated in and constitute a part of the specification. The drawings illustrate various features and embodiments of the invention, and together with the description serve to explain the principles and operation of invention.

### BRIEF DESCRIPTION OF THE DRAWINGS

FIG. 1 is a side elevational view of a soot delivery system of the present invention, cut-away to show a quantity of soot within a first housing and with a second housing shown in phantom about a soot delivery device;

FIG. 2 is a side elevational view of an electrostatic gun of the soot delivery device;

FIG. 3 is a partially schematic side elevational view of the soot delivery system in conjunction with a soot producing system;

FIG. 4 is a cross-sectional side view of a burner for use within the soot producing system;

FIG. 5 is a top view of a substrate with conductive materials; and

FIG. 6 is a partially schematic side elevational view of an optical component production line incorporating the soot producing system and soot delivery system of the present invention.

### DETAILED DESCRIPTION OF THE PREFERRED EMBODIMENTS

Reference will now be made in detail to the present preferred embodiments of the invention, examples for which are illustrated in the accompanying drawings. Wherever possible, the same reference numerals are used throughout the drawings to refer to the same or like parts.

For purposes of the description herein, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting unless the claims expressly state otherwise.

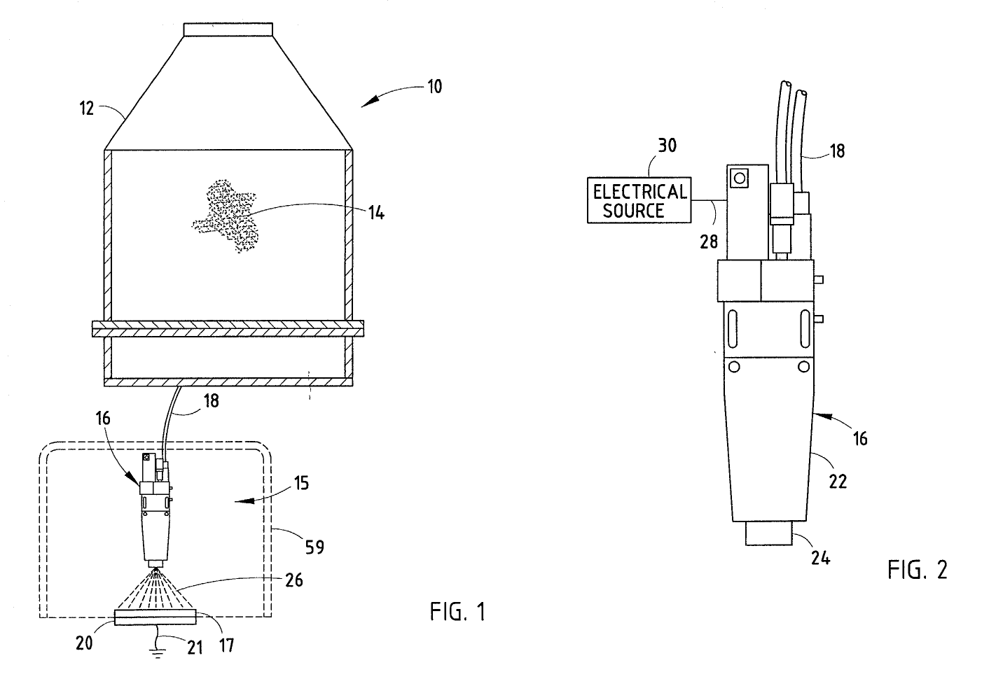

Referring initially to FIG. 1, there is shown a soot delivery system 10 for constructing an optical waveguide component embodying the present invention and used in its method. Delivery system 10 includes an enclosure or housing 12 that houses a glass producing soot 14 therein. Delivery system 10 includes a soot delivery device 15 that includes an electrostatic gun 16 which is in communication with housing 12 via a soot supply line 18. In operation, soot 14 flows to electrostatic gun 16 via supply line 18 where electrostatic gun 16 electrically charges the individual particles of soot 14 as soot 14 flows through electrostatic gun 16. Electrostatic gun 16 accelerates the soot towards a substrate 20, where soot 26 is deposited onto substrate 20 via the electrostatic attraction force between substrate 20 and the charged particles of soot. The soot 26 as deposited onto substrate 20 can be deposited across the entire substrate 20 and in patterns thereon as discussed below.

As illustrated, soot delivery device 15 includes electrostatic gun 16, however, it should be noted that any device adapted to provide soot 14 with an electric charge and accelerate soot 14 towards a receiving substrate may be utilized. Electrostatic gun 16 is preferably provided in the form of a commercially available gun, such as the Model 8830 Arc Spray System, available from TAFA Incorporated of Concord, N.H. However, other electrostatic spray guns may be utilized. Electrostatic gun 16 (FIG. 2) includes a body section 22, a directional nozzle 24 for concentrating the direction of sprayed soot 26 (FIG. 1) in a unified direction, and an electrical supply line 28 in communication with an electrical source 30. Electrostatic gun 16 is adapted to receive soot 14 from housing 12, provide an electrostatic charge to soot 14 as it passes through electrostatic gun 16, resulting in a pattern of accelerated soot 26 directed towards substrate 20.

In the preferred embodiment, electrostatic forces guide soot particles 26 onto substrate 20 so that uniform layers 17 of soot particles 14 deposit upon substrate 20. This is due to the electrostatic charge provided to soot 14 via the electrostatic gun 16, and an electrostatic charge on the substrate 20. In the illustrated example, substrate 20 is grounded to an outside ground, although it should be noted the substrate 20 may also be coupled to a positive or negative voltage source as described below.

It should be noted that although the illustrated substrate 20 has a planar geometrical shape as illustrated, numerous other geometrical shapes and orientations useful in manufacturing optical waveguide devices and components may be utilized. These other shapes and orientations include, but are not limited to, those associated with optical waveguide fibers, lightwave optical circuits, narrow band wavelength demultiplexers, dynamic gain flattening filters, MEMS optical switches, liquid crystal cross-connects, phasers and electro-optic devices.

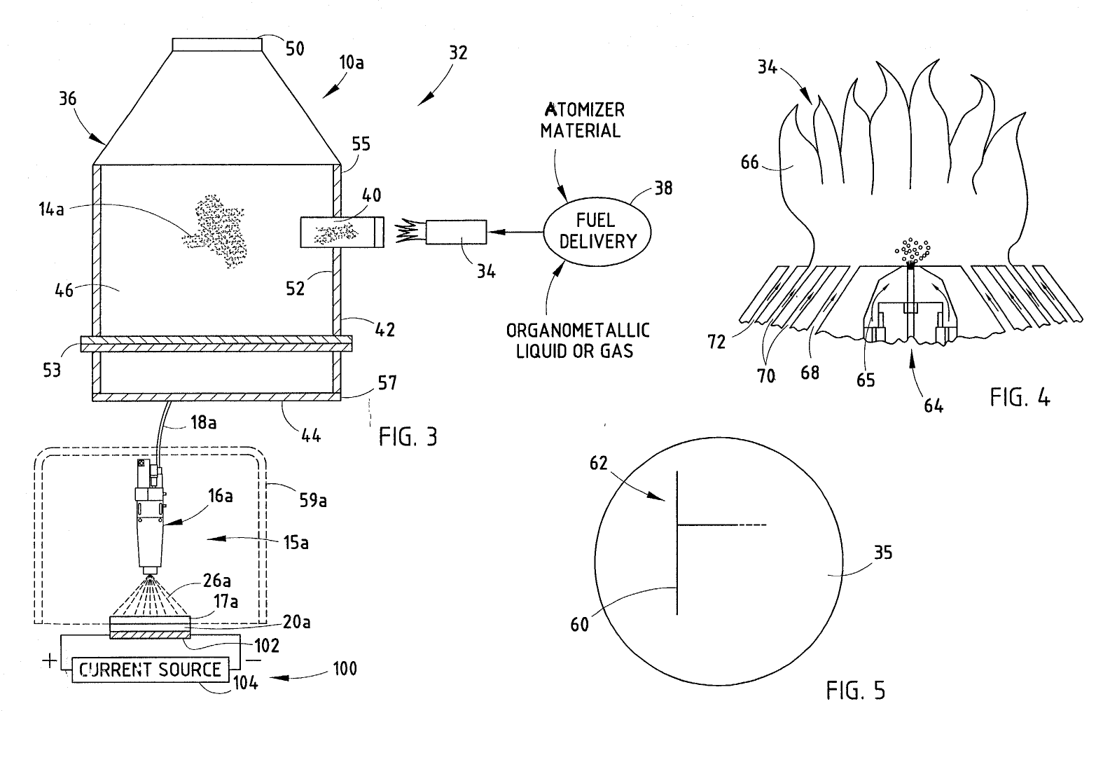

The reference numeral 10a (FIG. 3) generally designates another embodiment of the soot delivery system as it is utilized in cooperation with a soot producing system 32. Since soot delivery system 10a is similar to the previously described soot delivery system 10, similar parts appearing in FIG. 1 and FIG. 3, respectively, are represented by the same, corresponding reference numeral, except for the suffix “a” in the numerals of the latter. Soot producing system 32 is adapted to produce and collect soot 14a for glass melting manufacturing those optical components and devices as noted above. In general, surface area collector 36 captures soot for such uses as (but not limited to) glass melting. Surface area collector 36 is designed to fit into existing soot deposition equipment.

In the illustrated example, soot producing system 32 includes a waveguide burner 34 and a surface area collector 36. Waveguide burner 34 preferably uses a precursor/liquid delivery system 38 in order to produce soot 14a. It should be noted that while a liquid delivery system is used in the illustrated example, liquid delivery or conventional vapor delivery burners are able to be used with the surface area collector 36. Organometallic liquid precursors are pumped to waveguide burner 34 with an atomizing gas compound of a mixture of CF₄ and nitrogen, CF₄ and oxygen, or other like gases, such as perfluoro compounds, nitrogen/oxygen mixtures or argon, which are reacted within burner 34. An exemplary organometallic liquid for the present invention includes octamethylcyclotetrasiloxane (OMCTS) Si₄O₄C₈H₂₄. The CF₄—N₂ mixture atomizes the organometallic liquid precursor and provides a source of fluorine in the soot. Although a particular method for producing soot 14a is disclosed herein, any method known for producing a glass producing soot may be utilized.

While a fluorine doped precursor is used as an example herein, any other desired elements may be doped into the soot by choosing an appropriate precursor dopant, as will be appreciated by a person of skill in the art. The precursor dopant includes the element desired to be doped into the soot. Elements that may be doped into the soot include, for example, fluorine, germanium, titanium, aluminum, phosphorus, rare earth elements, sulfur, zirconium, antimony and combinations thereof. The precursor may also include metal, metal oxides, non-metal oxides, and combinations thereof.

Waveguide burner 34 of the present invention burns liquids directly and does not require materials to be vaporized before being burned in a waveguide burner as is done in prior art approaches. Using the fluorine dopant noted above as an example, prior art approaches achieve around 3 weight percent fluorine within the resultant soot, whereas the present invention achieves around 15 weight percent fluorine within the resultant soot. Moreover, the present invention is not limited to only using a fluorine doped precursor, but also is applicable to using any precursor substance, especially those substances that are impractical to place in a vapor phase, such as those having relatively low vapor pressure. As a non-limiting example, the present invention also generates and deposits soot containing relatively high concentrations of GeO₂ dopant. Moreover, the present invention includes not only the use of a single burner, but using multiple burners (not shown) with a collector sufficiently large enough to process the substrates from the multiple burners.

The technique of the present invention produces soot 14a which is intrinsically of a higher purity than batch melts. Multi-component soots are produced in waveguide burner 34 are more intimately mixed, and of a smaller particle size than most batch materials purchased for melting processes. The resulting waveguide soots melt at lower temperatures, and produce more homogeneous cord-free glasses. This is especially advantageous for viscous, high melting glasses, such as the alkali-antimony-alumino-silicates used as optical amplifier materials. Again, as a non-limiting example, waveguide burner 34 is provided with alkoxide solutions as precursors in order to produce the alkali-antimony-alumino-silicates.

FIG. 4 depicts a cross-sectional view of burner 34. Burner 34 incorporates within its structure an atomizer 64, which injects very finely atomized liquid reactant particles into flame 66. Soot is produced by combustion of the liquid reactant and is collected by the surface area collector 36 (FIG. 3). As shown by FIG. 4, burner 34 includes a series of concentric channels surrounding atomizer 64. Oxygen is delivered to flame 66 through channels 68 and 70. A premix of oxygen and a fuel such as methane is conducted to the flame through outermost channel 72.

As a non-limiting example, channel 65 contains a mixture of CF₄ and N₂. The CF₄—N₂ mixture atomizes the organometallic liquid precursor into particles which is burned in the flame of the burner. The CF₄—N₂ atomizing mixture provides the source of fluorine in the soot. Mixtures other than CF₄ may be used, such as SF₆. The atomizing mixture is varied in order to vary the amount of fluorine or other dopant in the soot depending upon the specific application.

Soot 14a is preferably directed into an interior chamber 46 of surface area collector 36 through an opening or aperture 40. It should be noted that in the present example, collector 46 is utilized in a similar manner as housing 12 described above, in that collector 46 is used to house soot 14a for delivery to an associated delivery device 15a. Soot 14 is directed through aperture 40 and rotates and swirls within chamber 46 of surface area collector 36 and collects upon walls 42 and/or floor 44 of collector 36. The top of collector 36 includes a fume exhaust 50 which allows gases from within chamber 46 to adjust to the soot capture rate.

Soot 14 is extracted after a period of time when the interior chamber 46 of collector 36 has sufficiently cooled. A flange 53 depicts where an upper portion 55 of surface area collector 36 detaches from a lower portion 57 of collector 36 in order to extract soot 14 if so desired. To aid in soot removal and reduce the possibility contamination, the inside of chamber 46 in one embodiment contains a heat resistant coating 52 that is compatible with the materials being collected. Coating 52 includes, but is in no way limited to, being made of silica so that metallic contamination from the collector is eliminated. However, it is to be understood that the present invention includes using other chemically inert and heat resistant materials, such as, but not limited to, quartz.

Surface area collector 36 in this embodiment as well as with other embodiments includes a water cooled shell/jacket (not shown) that encircles the outside diameter of chamber 46. The water cooled shell enhances the thermophoresis and capture efficiency of the surface area collector 36. Due at least to the enhanced thermophoresis, i.e., the process by which particles move in a temperature gradient from hot regions to cooler regions, surface area collector 36 collects soot 14 in a substantially uniform manner on its walls 42 and floor 44.

The operating temperature of the surface area collector 36 is typically around 300° C. and thus does not bake out the fluorine from soot 14a as do the prior art approaches since the prior art approaches operate at a much higher temperature. Thus, the approach of collecting the deposit in a 300° C. environment that is removed from where burner 34 is located has decided advantages since soot 14a is not substantially reheated by subsequently deposited soot. Preferably, the collector environment is about two feet removed from the burner location. However, the distance of two feet is only an exemplary distance as other distances will achieve the effect of the present invention as it is dependent upon the application at hand. Such exemplary non-limiting distances include six, twelve, eighteen inches and greater between the flame of burner 34 and where soot 14a is deposited within chamber 46 of surface area collector 36. This environment has substantial advantages versus a 2000° C. environment since it helps in part to improve the amount of fluorine, or other dopant, retained in the deposited material. It should be understood that the present invention is not limited to operating around a 300° C. temperature, but includes collecting soot from a burner at a distance that allows the soot not to be reheated.

In a preferred embodiment, soot 14a is then supplied from chamber 46 of collector 36 to electrostatic gun 16 of soot delivery device 15a via soot supply line 18a. In this manner, an optical waveguide component production line is created, wherein soot producing system 32 produces a highly pure soot 14a that is in turn utilized to produce optical waveguide components via delivery system 10a that efficiently and accurately supplies soot 14a to substrate 20a. The soot 14a is attracted to the associated substrate 20a via the electrostatic attraction forces therebetween. As described above, soot 14a receives an electrostatic charge from electrostatic gun 16a. Substrate 20a may be grounded to an outside source 21 as noted above. Alternatively, a source 100 for generating a charge near substrate 20a that cooperated with the electrostatic charge of soot 14a may be utilized to enhance the attraction of soot 14a to substrate 20a. In the illustrated example, an electromagnet 102 having a ferrous core wrapped with a wire that carries a D.C. current is placed near substrate 20a as soot 14a is sprayed from electrostatic gun 16a towards substrate 20a. The electromagnet 102 creates an electromagnetic field near substrate 20a that cooperates with the electrostatic charge of soot 14a, thereby attracting soot 14a to substrate 20a. Although an electrostatic force is used as an example, other methods and devices capable of generating a charge that cooperates with the electrostatic charge of soot 14a may be utilized. As illustrated, a current source 104 provides an electrical current to electromagnet 102.

In an alternative embodiment, a housing 59 (FIGS. 1 and 3) is located about soot delivery devices 15 and 15a, thereby containing any over-spray soot supplied by soot delivery devices 15 and 15a but not captured on substrates 20 and 20a.

FIG. 5 depicts an embodiment of substrate 20 wherein a lightwave optical component circuit is created on substrate 20. First, conductive materials 60 are deposited in the pattern 62 of a desired lightwave optical component circuit. Substrate 20 with circuit pattern 62 is then charged. The charged circuit pattern 62 being of a different material with different conductive properties than substrate 20 attracts soot 14 such that soot 14 is deposited at least substantially on charged circuit pattern 62. This approach produces an optical pathway without requiring masking and etching processes to create the pathway.

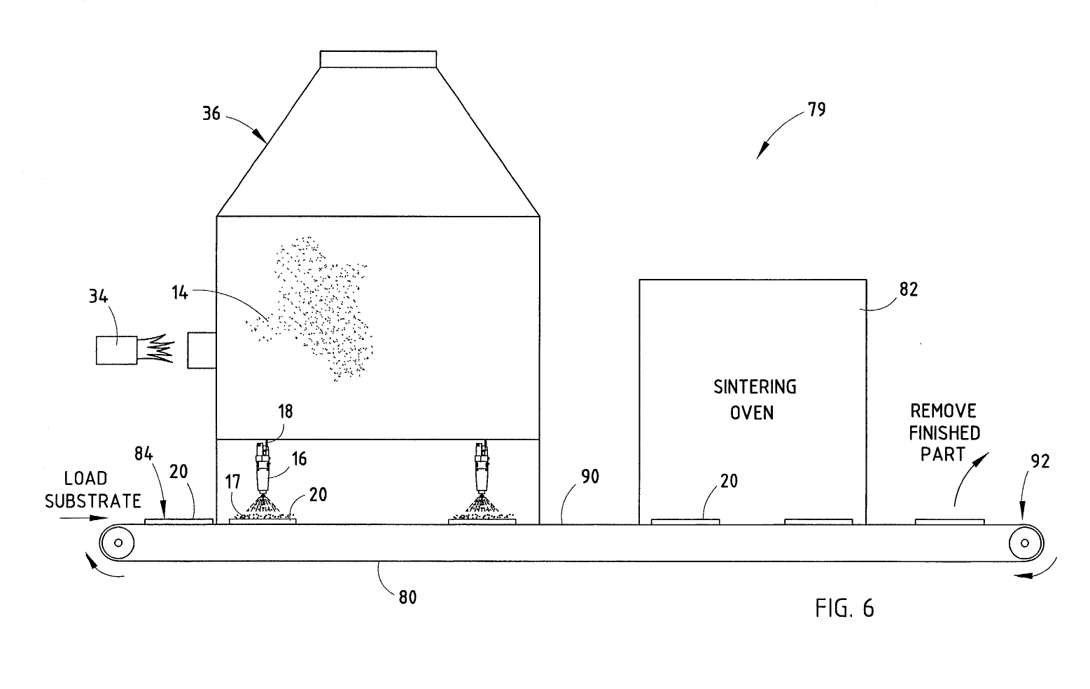

FIG. 6 depicts an optical component production line 79 for efficiently processing multiple substrates (e.g., planar substrates) according to the teachings of the present invention and which utilized the concepts of the soot delivery system 10 and conveying system 80 that conveys substrates 20 in proximity to electrostatic gun 16 and a sintering oven 82. Specifically, substrates 20 are loaded at the upstream end 84 of conveying system 80 so that substrates 20 can pass in close proximity to the electrostatic gun 16 and receive soot 14 thereon. Soot 14 is supplied from collector 36 to electrostatic gun 16 via soot delivery line 18. Soot 14 is then sprayed onto substrates 20, thereby creating a layer of deposited soot 17 on each substrate 20.

Substrates 20 remain in proximity to gun 16 for an amount of time that allows a sufficient amount of soot 14 to be deposited upon substrates 20. After a sufficient deposition has occurred, conveyor system 80 conveys substrates 20 to sintering oven 82 so that the soot deposition on substrates 20 can be sintered. After sintering of the deposition has occurred, conveyor system 80 conveys substrates 20 from sintering oven 82 to the downstream end 92 where the finished parts are removed.

It will become apparent to those skilled in the art that various modifications to the preferred embodiment of the invention as described herein can be made without departing from the spirit or scope of the invention as defined by the appended claims.

The invention claimed is:

1. A method for producing an optical waveguide component, comprising:
providing a glass producing soot;
providing a soot delivery device adapted to provide an electrostatic charge to the soot;
providing a substrate material adapted to receive the glass producing soot thereon;
delivering the soot to the delivery device;
accelerating the soot as it passes through the delivery device;
charging the soot as the soot passes through the delivery device with a sufficient charge to attract the soot to the substrate material; and
depositing the soot on the substrate material by spraying the soot onto the substrate material via the delivery device.

2. The method of claim 1, wherein the delivery device of the soot delivery device providing step includes an electrostatic gun, and wherein the soot depositing step includes spraying the soot onto the substrate in a unified direction via the electrostatic gun.

3. The method of claim 2, further including:
using a charging apparatus to generate an electrostatic force proximate to the substrate that cooperates with the charge of the soot, thereby assisting in attracting the soot to the substrate.

4. The method of claim 3, further including:
grounding the substrate.

5. The method of claim 2, wherein the step of providing the soot further includes:
generating the soot via a burner having a flame that produces heat;
providing the generated soot to a surface area collector, the surface area collector in communication with the delivery device; and
collecting the soot within the surface area collector, the burner being disposed such that the soot collected in the surface area collector is substantially unaffected by the heat from the burner.

6. The method of claim 5, wherein the step generating the soot includes directly burning at least a liquid material.

7. The method of claim 5, further including:
delivering a precursor dopant to the burner in order to dope the generated soot.

8. The method of claim 7, wherein the precursor dopant includes an element selected from the group consisting of fluorine, germanium, titanium, aluminum, phosphorus, rare earth elements, sulfur, zirconium, antimony and combinations thereof.

9. The method of claim 5, further including:
delivering a liquid precursor to the burner in order to generate the soot and for delivering atomizing gas for atomizing the liquid precursor into droplets that are vaporized in the flame and reacted to form soot.

10. The method of claim 5, further including:
delivering a precursor as a vapor to the burner in order to generate the soot.

11. The method of claim 5, further including:
conveying a plurality of the substrates in proximity to the delivery device such that the plurality of substrates receive the soot thereon via the delivery device.

12. The method of claim 11, further including:
conveying the plurality of substrates from proximate the delivery device to a sintering oven; and
sintering the plurality of substrates that have collected the soot.

13. The method of claim 11, further including:
sintering the plurality of substrates that have collected the soot.

14. The method of claim 1, further including:
providing the substrate with a conductive material such that the conductive material defines an optical pathway; and
charging the conductive material so that the soot is attracted to the conductive material of the substrate.

15. The method of claim 1, further including:
providing a housing about the delivery device; and
containing any over-spray soot sprayed by the delivery device within the housing.

16. The method of claim 1, further including:
using a charging apparatus to generate an electrostatic force proximate to the substrate that cooperates with the charge of the soot, thereby assisting in attracting the soot to the substrate.

17. The method of claim 1, further including:
grounding the substrate.

18. The method of claim 1, further including:
conveying a plurality of the substrates in proximity to the delivery device such that the plurality of substrates receiving the soot thereon via the delivery device.

19. The method of claim 18, further including:
sintering the plurality of substrates that have collected the soot.

20. A method for producing an optical waveguide component, comprising:
generating a glass producing soot via a burner having a flame that produces heat;
providing the generated soot to a surface area collector;
collecting the soot within the surface area collector, the burner being disposed such that the soot collected in the surface area collector is substantially unaffected by the heat from the burner
providing a soot delivery device adapted to provide a charge to the soot;
providing a substrate material adapted to receive the glass producing soot thereon;
delivering the soot from the surface area collector to the delivery device;
accelerating the soot as it passes through the delivery device;
charging the soot as the soot passes through the delivery device with a sufficient charge to attract the soot to the substrate material;
depositing the soot on the substrate material by spraying the soot onto the substrate material via the delivery device;
conveying a plurality of the substrates in proximity to the delivery device such that the plurality of substrates receive the soot thereon via the delivery device;
conveying the plurality of substrates from proximate the delivery device to a sintering oven; and
sintering the plurality of substrates that have collected the soot.

21. An apparatus for producing an optical waveguide component, comprising:
an enclosure for housing a glass producing soot therein;
a soot delivery device in communication with the enclosure for receiving the glass producing soot therefrom, the soot delivery device adapted to provide an electrostatic charge to the glass producing soot and accelerate the glass producing soot towards a substrate as the glass producing soot is passed through the soot delivery device, thereby causing an electrostatic attraction force between the glass producing soot and the substrate and depositing the glass producing soot onto the substrate.

22. The apparatus of claim 21, wherein the delivery device includes an electrostatic gun, and wherein the electrostatic gun sprays the glass producing soot in a unified direction.

23. The apparatus of claim 22, further including:
a charging apparatus that generates an electrostatic force proximate to the substrate, wherein the electrostatic force generated by the charging apparatus cooperates with the charge of the soot, thereby assisting in attracting the soot to the substrate.

24. The apparatus of claim 22, wherein the substrate is grounded.

25. The apparatus of claim 22, further including:
a burner having a flame that produces heat for producing the soot; and
a surface area for collecting the soot as produced by the burner, the burner being disposed such that the soot collected in the surface area collector is substantially unaffected by the heat from the burner.

26. The apparatus of claim 25, further including:
a precursor delivery system for delivering precursors to the burner to generate the soot.

27. The apparatus of claim 26, wherein the precursor delivery system is adapted to deliver the precursor in liquid form.

28. The apparatus of claim 26, wherein the precursor delivery system is adapted to deliver the precursor in vapor form.

29. The apparatus of claim 22, further including:
a conveyor for delivering a plurality of the substrates to the soot delivery device.

30. The apparatus of claim 29, further including:
a sintering oven receiving the plurality of substrates from the conveyor and sintering the plurality of substrates that have collected the soot.

31. The apparatus of claim 21, further including:
a housing positioned about the delivery device and containing any over-spray soot sprayed by the delivery device within the housing.

32. The apparatus of claim 21, further including:
a charging apparatus that generates an electrostatic force proximate to the substrate, wherein the electrostatic force generated by the charging apparatus cooperates with the charge of the soot, thereby assisting in attracting the soot to the substrate.

33. The apparatus of claim 21, wherein the substrate is grounded.

34. The apparatus of claim 21, further including:
a burner having a flame that produces heat for producing the soot; and
a surface area for collecting the soot as produced by the burner, the burner being disposed such that the soot collected in the surface area collector is substantially unaffected by the heat from the burner.

35. The apparatus of claim 34, further including:
a precursor delivery system for delivering precursors to the burner to generate the soot.

36. The apparatus of claim 35, wherein the precursor delivery system is adapted to deliver the precursor in liquid form.

37. The apparatus of claim 35, wherein the precursor delivery system is adapted to deliver the precursor in vapor form.

38. The apparatus of claim 21, further including:
a conveyor for delivering a plurality of the substrates to the soot delivery device.

39. The apparatus of claim 38, further including:
a sintering oven receiving the plurality of substrates from the conveyor and sintering the plurality of substrates that have collected the soot.
